(19) United States
(12) Patent Application Publication
(10) Pub. No.: US 2012/0069467 A1
(43) Pub. Date: Mar. 22, 2012

(54) MAGNETIC RECORDING MEDIUM AND MAGNETIC DISK DRIVE USING THE SAME

(75) Inventor: Jianhua LI, Sagamihara (JP)

(73) Assignee: HITACHI, LTD., Tokyo (JP)

(21) Appl. No.: 13/168,575

(22) Filed: Jun. 24, 2011

(30) Foreign Application Priority Data
Jun. 29, 2010 (JP) 2010-147893

(51) Int. Cl. G11B 5/82; G11B 17/02

(52) U.S. Cl. 360/99.08; 360/135; G9B/5.293; G9B/17.002

(57) ABSTRACT

The present invention provides a magnetic recording medium and a magnetic disk drive using the same, capable of keeping flying height and posture of the head slider constant when a discrete track medium (magnetic recording medium) includes tracks as data zones, and non-data zones (groove) formed between adjacent tracks. The width of the discrete servo field for locating the position of the track in the radial direction is set to be smaller than a width of an end of a center pad formed on a head slider of the magnetic disk drive

### CLAIM OF PRIORITY

The present application claims of priority from Japanese patent application JP 2010-147893 filed on Jun. 29, 2010, the content of which is hereby incorporated by reference into this application.

### BACKGROUND OF THE INVENTION

1. Field of the Invention

The present invention relates to a magnetic recording medium having magnetic recording layers separated by grooves (non-data zones), and a magnetic disk drive using the magnetic recording medium.

2. Description of the Related Art

FIG. 1 illustrates an example of the magnetic disk drive. The magnetic disk drive serving as an information recording device includes a magnetic head that is formed of a recording element and a reproducing element. The recording element records data in a disk-shaped magnetic recording medium (magnetic disk) 106 having tracks, or erases the data recorded in the magnetic recording medium 106. The reproducing element reproduces the data recorded in the recording element. The magnetic head is buried in a head slider 118 installed in a suspension arm. The head slider 118 is pressed against the magnetic recording medium 106 by the suspension arm, while being flown by the rotating magnetic recording medium.

In order to improve recording density of the magnetic disk drive, it is considerably important to accurately move the magnetic head to the target track. Normally, the magnetic disk drive employs a separate type magnetic head provided with the recording element and the reproducing element.

When manufacturing the separate type magnetic head provided with the recording element and the reproducing element, it is difficult to provide the recording element and the reproducing element at the same position of the magnetic head. For this, gap of positions between the recording element and the reproducing element is measured, based on which the position of the recording element upon recording and the position of the reproducing element upon reproduction are adjusted so that those elements are accurately moved to the target track.

Recently, besides the magnetic recording medium having the magnetic layer formed on the entire surface of the generally employed disk, the discrete track medium has been proposed as disclosed in Japanese Patent Application Laid-Open Publication Nos. 2003-228927 and 2009-245534. FIGS. 2A to 2D are plan views each illustrating the discrete track medium. Referring to FIGS. 2A to 2D, a discrete track medium (magnetic disk) 200 includes data zones 210 each formed of a magnetic recording layer, and non-data zones (grooves formed in the magnetic recording layers) 212, which are alternately provided when seen from radial direction of the magnetic recording medium. The larger the radius becomes, the longer the circumferential lengths of the data zones 210, the non-data zones (grooves) 212, and servo zone become. A reference numeral 202 denotes a zooming discrete track medium. Reference numerals 204, 206 and 208 denote a data sector, a servo zone and a track, respectively.

The non-data zone (groove) 212 is formed between adjacent data zones 210 so that data are not recorded in the data zone other than the target one irrespective of short distance between those data zones 210. This makes it possible to improve the recording density of the discrete track medium (magnetic disk 200). Especially the data may be recorded using the rim of the magnetic head while preventing recording in the data zone 210 other than the target one. In the discrete track medium (magnetic disk) 200, the data zone 210 is preliminarily formed by alternately arranging the data zones 210 and the non-data zones (grooves) 212, and the positional relationship, thus, cannot be changed afterward.

### SUMMARY OF THE INVENTION

The discrete track medium 200 shown in FIGS. 2A to 2D is loaded in the magnetic disk drive shown in FIG. 1 so that flying performance is examined by the inventors. The structure and operation of the magnetic disk will be described.

A magnetic disk drive 102 shown in FIG. 1 includes at least one magnetic disk 106 for recording data, a spindle motor 108 for setting and rotating the magnetic disk 106, and an actuator 110 provided with plural comb-shaped actuator arms 112, and fixed to a base 104 with a pivot assembly 114.

There is provided a magnetic head portion that includes at least a magnetic recording element for recording data in the magnetic disk 106, and a magnetic reproducing element for reading the data recorded in the magnetic disk 106 inside the head slider 118. The head slider 118 is fixed to a flexure which is flexibly adhered to a leading end of a suspension 116. The suspension 116 exhibits spring property, and is associated with movement of the head slider 118. The suspension 116 serves to depress the head slider 118 against the magnetic disk 106. As a result, the head slider 118 flies above the magnetic disk 106 at a predetermined height.

A voice coil motor 120 rotates the actuator 110 so that the head slider 118 attached to the leading end of the suspension 116 is driven from an inner circumference 126 to an outer circumference 128 of the data zone of the magnetic disk along a slider path 124 shown in FIG. 1.

A carbon protective layer on the surface of the magnetic disk 106 is coated with a perfluoropolyether (PFPE) film 122 through dipping process for protecting the magnetic disk 106 from wear and corrosion. For example, PFPE Z, PFPE Z-dol, PFPEZ-tetraol, and ZTMD (Z-Tetraol multidentate) as the lubricant with polydentate structure may be used as the appropriate PFPE film.

Rotation of the magnetic disk 106 catches air therearound on the surface. The path on which the caught air flows is narrowed in the space between the surface of the head slider 118 opposite the magnetic disk 106, and the surface of the magnetic disk 106, and accordingly, air in the narrowed path is compressed. Then the force for moving the head slider 118 in the direction away from the magnetic disk 106 is raised. The aforementioned force and the force exerted from the suspension 116 to the head slider 118 to approach the magnetic disk 106 relatively act with each other. As a result, the head slider 118 is kept flying above the surface of the magnetic disk 106 in proximity.

The discrete track medium (magnetic disk) 200 shown in FIGS. 2A to 2D is loaded in the magnetic disk drive 102 and the flying performance is examined. It is then found that flying height of the head slider 118 cannot be stabilized. FIG. 7 represents examination results with respect to the flying property.

FIG. 7 is a graph indicating relation between time [ms] as X-axis and flying height [nm] as Y axis, which represents the flying height measured over time when the head slider 118 moves above the discrete track medium (magnetic disk) 200 while flying. An area 700 encircled by dotted line denotes the time points at which the head slider 118 passes the servo zone 206 from the data sector 204. Especially the time point where the flying height sharply drops corresponds to the servo zone (length in the circumferential direction).

As clearly indicated by the graph shown in FIG. 7, the area 700 encircled by dotted line corresponds to the state where the head slider 118 is within the servo zone 206. As the magnetic field space defined by the head slider 118 and the discrete track medium (magnetic disk) 200 changes, the flying height of the head slider 118 changes by a large amount, which may prevent the head slider 118 from accurately writing the servo signal in the discrete track medium (magnetic disk) 200.

In the area 700 encircled by dotted line, the servo signal cannot be correctly read, which is expected to cause the risk of difficulty in normal operation of the magnetic disk drive.

In the area 700 encircled by dotted line, the head slider 118 vibrates violently, thus causing significant change in the magnetic field space. There may be the risk of interfering with accurate reading and writing of the signal by the head slider 118.

In order to improve the recording density without deteriorating reliability of the magnetic disk drive, it is necessary to keep the flying posture of the head slider 118 constant while maintaining its flying height as low as possible. The head slider 118 needs to be kept flying at low height while it is flying above the data sector 204 and the servo zone 206.

The present invention provides a magnetic recording medium and a magnetic disk drive using the same, capable of keeping flying height and posture of the head slider constant when the magnetic recording layers are separated by grooves (non-data zone).

The present invention provides a magnetic recording medium used for a magnetic disk drive, which is provided with plural data tracks, and discrete servo fields for locating respective positions of the data tracks. A width W of the discrete servo field in a rotation radial direction of the magnetic recording medium is smaller than a width SL of a center pad end of a head slider installed in the magnetic disk drive, and equal to or larger than an interval between the data tracks.

The present invention further provides a magnetic disk drive provided with a magnetic recording medium, a motor for rotating the magnetic recording medium, a head slider, and a center pad provided for the head slider and includes a magnetic head. The magnetic recording medium includes plural data tracks and discrete servo fields for locating each position of the plural data tracks. A width W of the discrete servo field in a rotation radial direction of the magnetic recording medium is smaller than a width SL of an end of the center pad, and equal to or larger than an interval between the data tracks.

According to an aspect of the present invention, the width W of the discrete servo field in the rotating radial direction of the magnetic recording medium is set to be smaller than the width SL of the center pad end of the head slider installed in the magnetic disk drive. This makes it possible to provide the magnetic recording medium and magnetic disk drive using the same, capable of keeping the flying height and posture of the head slider constant.

### BRIEF DESCRIPTION OF THE DRAWINGS

FIG. 1 is a schematic view of a magnetic disk drive;

FIGS. 2A to 2D are plan views of a magnetic recording medium as related art, wherein FIG. 2A shows a general view and a zooming discrete track medium; FIG. 2B shows a servo zone; FIG. 2C shows a data sector; and FIG. 2D shows both the servo zone and the data sector;

FIG. 3 is a general plan view of the magnetic recording medium and an enlarged portion according to a first embodiment;

FIG. 4 is a general plan view of the magnetic recording medium and an enlarged portion according to a second embodiment;

FIG. 5 is a partially enlarged plan view of the magnetic recording medium shown in FIG. 3;

FIG. 6 is a view illustrating an example of a servo pattern of the discrete track medium;

FIG. 7 is a view representing change in a flying height over time when the head slider moves from the data region to the servo zone;

FIG. 8 is a view representing change in a flying height over time when the head slider moves from the data sector to the servo zone with various widths;

FIG. 9 is a view representing relation between the normalized flying height and a width of the discrete servo field in a radial direction; and

FIG. 10 is a schematic plan view of the head slider.

### DESCRIPTION OF THE PREFERRED EMBODIMENTS

Structures of the data sector and the servo zone are examined in view of instability of the flying height of the head slider upon its movement from the data sector 204 to the servo zone 206.

Servo sectors provided in the respective tracks of the discrete track medium (magnetic disk) 200 are aligned in the circumferential direction together with those in the other tracks. As a result, the servo sectors extend toward the radial direction.

In the servo zone which includes the servo sectors, a discrete servo field 600 includes 6 patterns of a preamble (an automatic gain control field: AGC)/servo mark (servo-timing-mark field: STM) 604, cylinder information (a track number Gray code field) 606, sector information (an index field) 608, burst information (a position-error-signal field: PES) 610, and a padding field 612 as shown in FIG. 6. The preamble 604 measures each timing of subsequent information (servo mark 604, cylinder information 606, sector information 608, burst information 610, and padding field 612), and parameter gain. The servo mark 604 functions as a timing reference for reading the servo information with respect to the sector information 608 and the burst information 610. The sector information 608 contains track numbers. The data regions 602 are provided preceding and subsequent to the discrete servo field 600.

The burst information 610 contains PES burst A-D as data for fine adjustment of the head in the radial direction. The respective PES burst A-Ds are sequentially provided in a magnetic transfer region at predetermined intervals.

The servo zone 206 and the data sector 204 of the discrete track medium (magnetic disk) 200 are formed in fan-like forms from a rotating center of the magnetic disk in the radial direction. The grooves formed in the servo zones 206 and the data sectors 204 are not sufficiently filled. They are left in the disk surface of the discrete medium (magnetic disk) 200. Basically, positions and configurations of the grooves and recording regions of the discrete servo field 600 are different from those of the track. The head slider 118 passes the grooves and random portions of the discrete servo field while moving from the data region to the servo zone above the discrete track medium.

As the head slider 118 passes the grooves and random portions of the discrete servo field, air flow between the head slider 118 and the discrete track medium (magnetic disk) 200 is changed. As a result, the pressure applied to the surface of the ABS (air bearing surface) changes, and accordingly, the flying posture of the head slider 118 also changes. The head slider 118 includes a magnetic head 150 attached to the center pad end 160 as shown in FIG. 10 so that the track moves orthogonally (circumferential direction) to the longitudinal direction (radial direction of the magnetic disk) of the magnetic head.

The grooves of the data sectors 204 and the servo zones 206 are sufficiently filled for planarization. However, irregularities ranging from 0.5 nm to 2.0 nm are left on the surface, failing to completely eliminate instability of the flying height of the head slider.

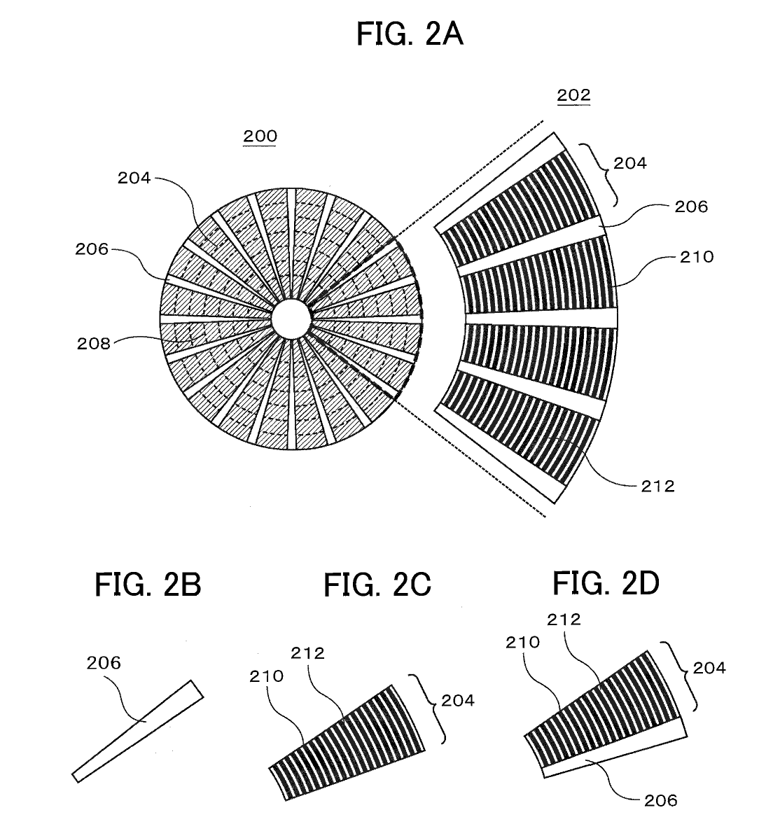

As a result of further examination, the servo zone 206 shown in FIG. 2B is divided into plural sections in the radial direction so that the width of the servo zone in the radial direction is smaller than a width SL of the center pad end. The results show that the instability of the flying height of the head slider is improved.

Embodiments of the present invention will be described hereinafter.

### First Embodiment

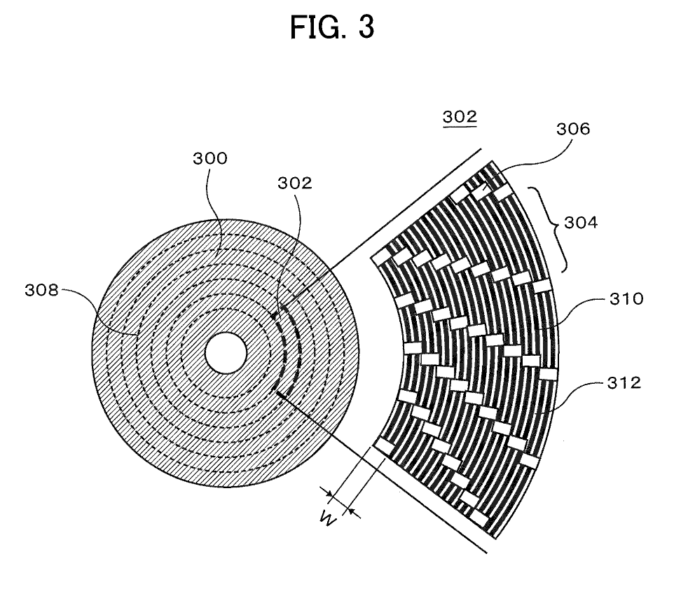

A first embodiment will be described referring to FIGS. 3, and 8 to 10. Those described above will be applicable herein unless it is specifically defined in this embodiment.

FIG. 3 illustrates a discrete track medium (magnetic disk) 300 according to the first embodiment. A zooming discrete track medium 302 enclosed by dotted line is shown to the right. The discrete track medium (magnetic disk) 300 shown in FIG. 3 includes data sectors 304 each formed of tracks 308 each as the data zone 310 and a non-data zone (groove) 312 which cannot record data on the surface, and the discrete servo fields 306. The data zones 310 have the same magnetic recording layers as those of the tracks 308 in the discrete track medium.

The discrete servo field 306 of this embodiment has the same structure as the one illustrated in FIG. 6, which is formed by dividing the fan-like servo zone shown in FIG. 2 in the radial direction along the circumference with respect to the rotating center of the magnetic disk. The discrete servo field 306 shown in FIG. 3 has its size smaller than that of the servo zone 206 shown in FIG. 2. Each size of the discrete servo field 306 is illustrated to be the same on the drawing. Actually, however, the circumferential length of the servo zone in the region with smaller rotation radius becomes shorter. The side in the circumferential direction forms an arc corresponding to the radius.

The discrete servo fields 306 are formed on the surface of the discrete track medium (magnetic disk) 300 in proximity when seen from the radial direction. The respective discrete servo fields 306 are provided not to be in contact with one another in the entire radial direction for ensuring the function of the discrete servo field.

The discrete servo field 306 has the same widths W in the radial direction, which makes it possible to manufacture the discrete track medium with high reliability yet with simple design.

Each center line of the discrete servo field 306 is positioned along the rotation radial direction of the magnetic disk 300 so that the divided discrete servo fields 306 are contained within the data sector defined by the adjacent servo zones 206 as shown in FIG. 2.

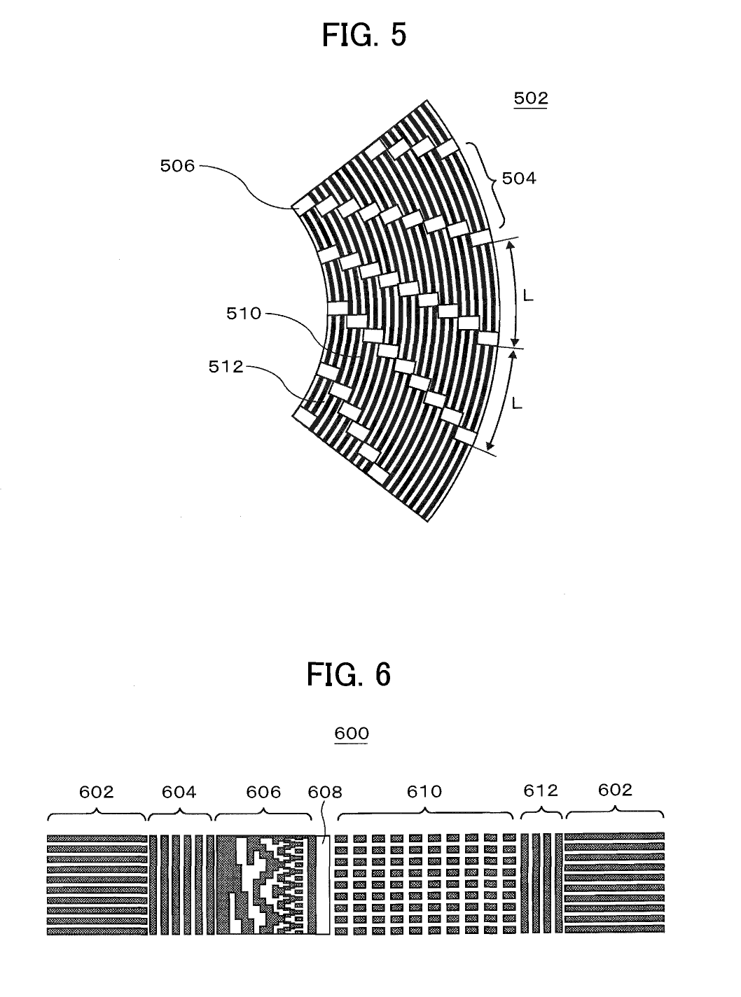

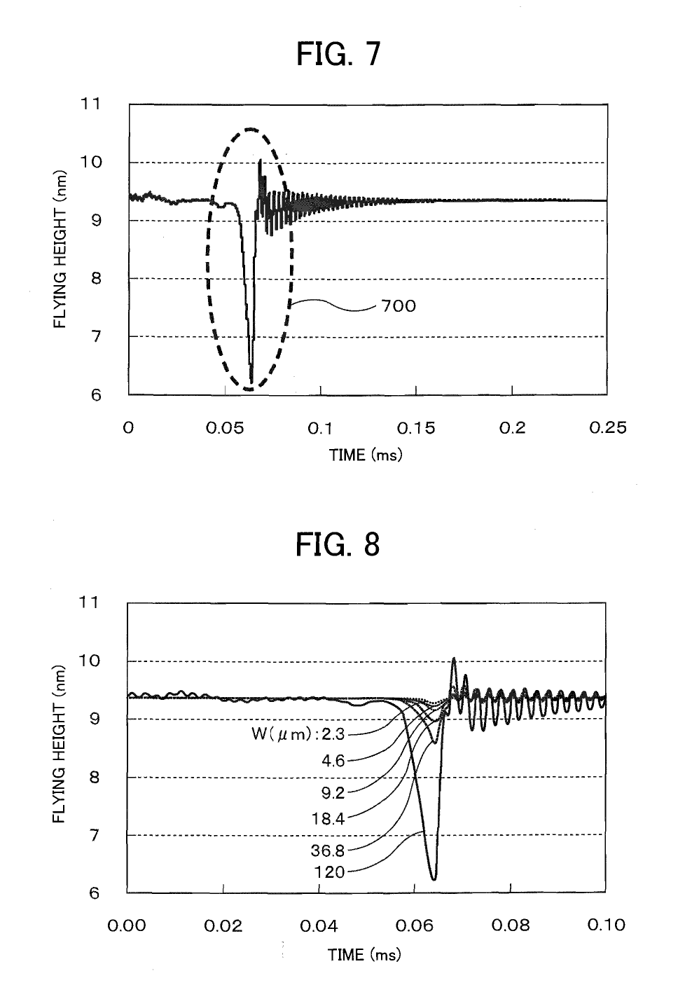

FIG. 5 shows a zooming discrete track medium 302 enclosed by dotted line in FIG. 3 (corresponding to a reference numeral 502 in FIG. 5). Discrete servo fields 506 are provided in the circumferential direction at predetermined intervals L. The interval L varies based on the radius of the magnetic disk 300. Each of the discrete servo fields 306 is formed on the circumference of the magnetic disk with the same rotation radius. As they are located each at equal interval on the circumference with smaller rotation radius, the interval between the discrete servo fields 306 on the same circumference becomes small. The area occupied by the discrete servo fields 306 to the entire area of the magnetic disk surface is the same as the area occupied by the servo zones 206 shown in FIGS. 2A to 2D to the entire area of the magnetic disk surface. A reference numeral 510 denotes a data zone of discrete track medium, a reference numeral 512 denotes a non-data zone (groove) of discrete track medium, and a reference numeral 504 denotes a data sector.

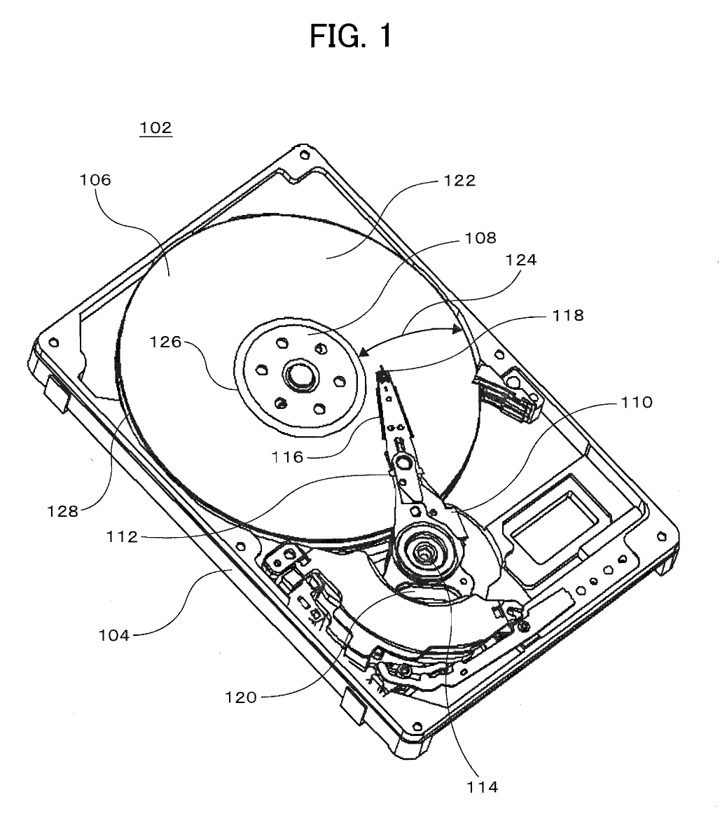

FIG. 8 shows measurement results of the flying height of the head slider which varies over time when moving from the data region to the discrete servo field while flying in the state where the magnetic disk shown in FIG. 3 is installed in the magnetic disk drive shown in FIG. 1. Values of the width of the discrete servo field in the radial direction are set to 120 μm, 36.8 μm, 18.4 μm, 9.2 μm, 4.8 μm, and 2.3 μm, respectively. The width SL of the center pad end of the head slider in use is set to 120 μm.

The view clearly shows that change in the flying height of the head slider is reduced by setting the width of the discrete servo field in the radial direction to be smaller than the width SL of the center pad end. It also shows that the smaller the width becomes, the smaller the resultant change becomes.

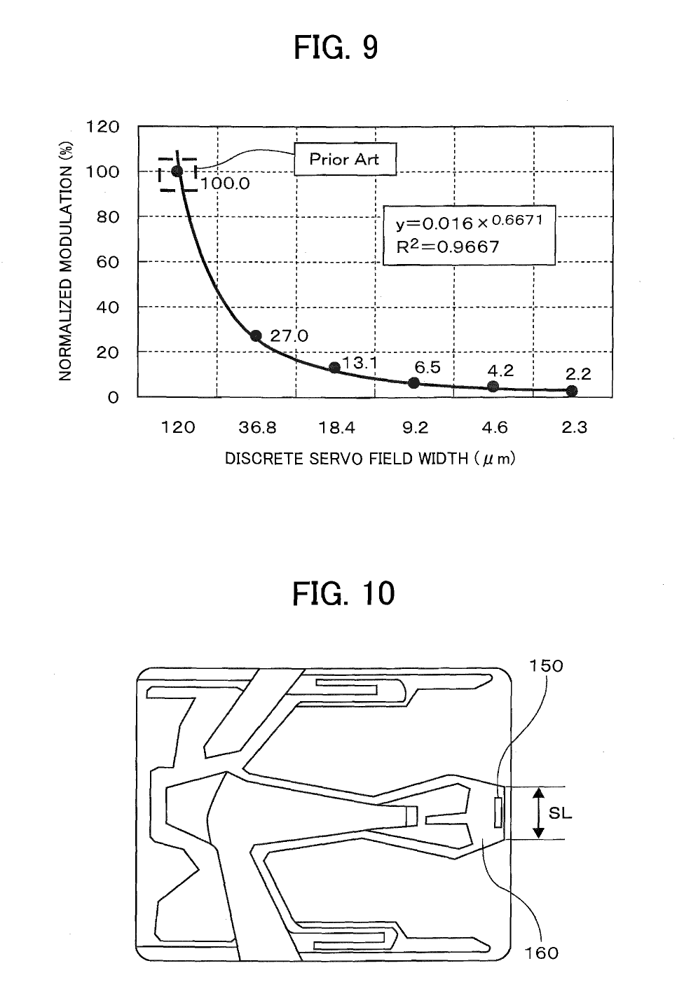

FIG. 9 is a graph having X-axis set as the width W of the servo zone in the radial direction, and Y-axis set as the normalized modulation using general values of the flying height based on the data shown in FIG. 8. Assuming that the normalized modulation (%) is designated as NM, the amount of change in the flying height of the head slider when the width of the servo zone in the radial direction is a general value (the value obtained by subtracting the minimum flying height from the maximum flying height of the head slider when the head slider flies above the servo zone shown in FIGS. 2A to 2D) is designated as h0, and the amount of change in the flying height of the head slider when the width W of the servo zone in the radial direction is smaller than a general value (the value obtained by subtracting the minimum flying height from the maximum flying height of the head slider when the head slider flies above the discrete servo field shown in FIG. 3) is designated as h, the NM is expressed by the following formula (1).

NM=(1−(h0−h)/h0)×100=h/h0×100 (%) (1)

Referring to FIG. 9, change in the flying height is reduced with decrease in the width W of the servo zone in the radial direction. The change amount y in the flying height may be expressed by the formula (2). The codes X and Y in the drawing correspond to W and y of the formula (2), respectively. The code R² in the graph denotes the correlated function coefficient, indicating that the formula exhibits the accuracy of approximately 97%.

y=0.016 W^{0.6671} (2)

As FIG. 9 and the formula (2) show, the width W of the servo zone in the radial direction is set to be smaller than the width SL of the center pad end (W<SL) so as to ensure reduction of change in the flying height of the head slider. In the case where the outer radius of the data sector of the magnetic disk in the rotating radial direction is set to R_{OD}, an inner radius is set to R_{ID}, and the number of divided areas of the servo zone is set to N (integer), the width W of the servo zone in the radial direction may be expressed by the formula of W=(R_{OD}−R_{ID})/N. Preferably, the width W is set to 10 μm or smaller. This makes it possible to suppress change in the flying height of the head slider to 7% or lower.

Preferably, the lower limit of the width W of the servo zone in the radial direction is set to the width of the data region (data track) in the radial direction because of difficulty in accurate reading of the servo zone using the head slider, thus leading to deteriorated reading accuracy.

As orbiting speed at the outer side is higher than the speed at the inner side of the magnetic disk with respect to the radial width W of the servo zone, and it is likely to be influenced by the concavity and convexity owing to the groove, the radial width of the servo zone at the outer side of the magnetic disk may be smaller than that of the inner side.

The embodiment provides the magnetic recording medium and the magnetic disk drive capable of keeping the flying height and flying posture of the head slider constant by making the radial width of the servo zone smaller than that of the center pad end even if the magnetic recording layers are separated by the grooves (non-data zone). Especially they are effective when the radial width of the servo zone is 10 μm or smaller.

### Second Embodiment

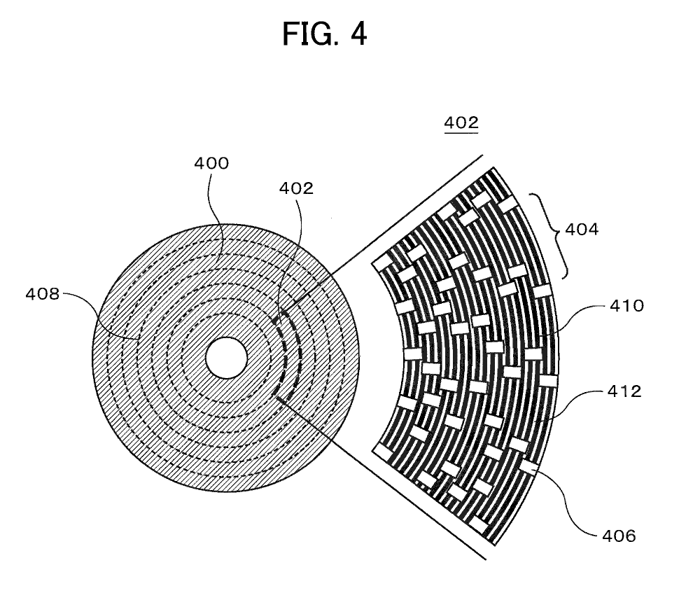

A second embodiment will be described referring to FIG. 4. Unless otherwise specified, descriptions explained in the first embodiment and unspecified in the present embodiment are applicable herein.

FIG. 4 is a plan view illustrating a general structure of the discrete track medium (magnetic recording medium) according to the embodiment and a zooming discrete track medium 402. A discrete track medium (magnetic disk) 400 according to the embodiment includes data sectors 404 formed of tracks 408 as data zone 410, each surface of which has a magnetic layer formed thereon and non-data zone (grooves) 412 that cannot record data, and a discrete servo fields 406. The non-data zone (groove) 412 is filled with a nonmagnetic material yet with insufficient surface flatness.

The structure of the discrete servo field 406 of the embodiment is the same as the one shown in FIG. 6. Likewise the first embodiment, the discrete servo field 406 is derived from dividing the servo zone 206 shown in FIG. 2 along the circumference of the magnetic disk with respect to the center of rotation in the radial direction. The discrete servo field 406 has the size smaller than that of the servo zone 206 shown in FIG. 2. Unlike the first embodiment in which the discrete servo fields 306 are regularly arranged in the rotation radial direction, the discrete servo fields 406 in the second embodiment are irregularly arranged. This makes it possible to improve freedom degree of design with respect to arrangement of the discrete servo fields 406.

The discrete servo fields 406 are arranged on the surface of the magnetic disk 400 without being adjacent with one another in the radial direction. Boundaries of the discrete servo fields 406 in the circumferential direction are set so as not to be in contact with one another. The area occupied by the discrete servo fields 406 to the entire area of the disk is the same as the area occupied by the servo zone 206 shown in FIG. 2 likewise the first embodiment.

The respective discrete servo fields 406 are provided at equal intervals in the direction of circumferences each having the same rotation radius of the magnetic disk. The interval between the regions varies in accordance with the radius of the magnetic disk 400, and becomes large as the rotation radius is increased.

Preferably, the width W of the servo zone in the radial direction is set to 10 μm or smaller. This makes it possible to suppress fluctuation of the flying height of the head slider to 7% or less with respect to fluctuation of the flying height in the general case.

In the embodiments, the magnetic disk has the size of 2.5 or 3.5 inches. However, the magnetic disk may have arbitrary size, and may be formed of aluminum or glass.

The head slider is applied to the one with a pico size (approximately 1250×1000×300 μm), or femto size (approximately 850×700×230 μm). The head slider may be formed of ceramics or intermediate metal compound. The width of the center pad end may be set to be in the range from 60 to 120 μm irrespective of the head slider size.

As has been described so far, in the embodiments, the radial width of the servo zone is set to be smaller than that of the center pad end so as to provide the magnetic recording medium, and the magnetic disk drive using the same capable of keeping the flying height and flying posture of the head slider constant even if the magnetic recording layer is divided by the groove (non recordable region).

What is claimed is:

1. A magnetic recording medium used for a magnetic disk drive, comprising:
a plurality of data tracks; and
discrete servo fields for locating respective positions of the data tracks,
wherein a width W of the discrete servo field in a rotation radial direction of the magnetic recording medium is smaller than a width SL of a center pad end of a head slider installed in the magnetic disk drive, and equal to or larger than an interval between the data tracks.

2. The magnetic recording medium according to claim 1, wherein a length of the discrete servo field in a circumferential direction becomes long as the discrete servo field is provided on a portion where a rotation radius of the magnetic recording medium becomes large.

3. The magnetic recording medium according to claim 1, wherein the discrete servo fields are arranged at equal intervals in a circumferential direction on a portion with the same rotation radius of the magnetic recording medium.

4. The magnetic recording medium according to claim 1, wherein each distance between the discrete servo fields in a circumferential direction is increased as the discrete servo fields are provided on a portion where a rotation radius of the magnetic recording medium becomes large.

5. The magnetic recording medium according to claim 1, wherein the discrete servo fields are provided having each center line arranged along a rotation radial direction of the magnetic recording medium.

6. The magnetic recording medium according to claim 1, wherein the width W is set to be equal to or smaller than 10 μm.

7. The magnetic recording medium according to claim 1, wherein the discrete servo field includes a preamble and a servo mark, cylinder information, sector information, burst information and padding information in a circumferential direction of the magnetic recording medium.

8. The magnetic recording medium according to claim 1, wherein the width W is expressed by a formula of: W=(R_{OD}−R_{ID})/N, where R_{OD} denotes an outer radius of a data region in a rotation radial direction of the magnetic recording medium provided with the data tracks, R_{ID} denotes an inner radius, and N denotes an integer.

9. A magnetic disk drive comprising:
a magnetic recording medium;
a motor for rotating the magnetic recording medium;
a head slider; and
a center pad provided for the head slider and includes a magnetic head,
wherein:
the magnetic recording medium includes a plurality of data tracks and discrete servo fields for locating each position of the plurality of data tracks; and
a width W of the discrete servo field in a rotation radial direction of the magnetic recording medium is smaller than a width SL of an end of the center pad, and equal to or larger than an interval between the data tracks.

10. The magnetic disk drive according to claim 9, wherein a length of the discrete servo field in a circumferential direction becomes long as the discrete servo field is provided on a portion where a rotation radius of the magnetic recording medium becomes large.

11. The magnetic disk drive according to claim 9, wherein the discrete servo fields are arranged at equal intervals in a circumferential direction on a portion with the same rotation radius of the magnetic recording medium.

12. The magnetic disk drive according to claim 9, wherein each distance between the discrete servo fields in a circumferential direction is increased as the discrete servo fields are provided on a portion where a rotation radius of the magnetic recording medium becomes large.

13. The magnetic disk drive according to claim 9, wherein the discrete servo fields are provided having each center line arranged along a rotation radial direction of the magnetic recording medium.

14. The magnetic disk drive according to claim 9, wherein the width W is set to be equal to or smaller than 10 4m.

15. The magnetic disk drive according to claim 9, wherein the discrete servo field includes a preamble and a servo mark, cylinder information, sector information, burst information and padding information in a circumferential direction of the magnetic recording medium.

16. The magnetic disk drive according to claim 9, wherein the width W is expressed by a formula of: W=(R_{OD}−R_{ID})/N, where R_{OD} denotes an outer radius of a data region in a rotation radial direction of the magnetic recording medium provided with the data tracks, R_{ID} denotes an inner radius, and N denotes an integer.
